(19) United States
(12) Patent Application Publication
(10) Pub. No.: US 2019/0361546 A1
(43) Pub. Date: Nov. 28, 2019

(54) TOUCH PANELS AND TOUCH DISPLAY DEVICES

(71) Applicant: Yungu (Gu'an) Technology Co., Ltd., Langfang (CN)

(72) Inventors: Xue PANG, Kunshan (CN); Bing WANG, Kunshan (CN); Tianchao ZHANG, Kunshan (CN); Peng XU, Kunshan (CN); Kun ZHU, Kunshan (CN)

(73) Assignee: Yungu (Gu'an) Technology Co., Ltd., Langfang (CN)

(21) Appl. No.: 16/533,955

(22) Filed: Aug. 7, 2019

Related U.S. Application Data
(63) Continuation of application No. PCT/CN2018/089972, filed on Jun. 5, 2018.

(30) Foreign Application Priority Data
Nov. 30, 2017 (CN) 201721642835.2

(51) Int. Cl. G06F 3/044; G06F 3/041

(52) U.S. Cl. CPC G06F 3/044; G06F 3/0412

(57) ABSTRACT

A touch panel and a touch display device are provided. The touch panel includes: a plurality of first touch electrode patterns comprising first touch units and a connection unit connecting two adjacent first touch units; second touch electrode patterns intersectedly insulated from the first touch electrode patterns, wherein the second touch electrode patterns includes independent second touch units, and at least one bridge structure connecting two adjacent second touch units. The bridge structure is provided with two bridge units. One bridge unit includes at least two metal bridges and a connecting portion connecting metal bridges. The metal bridges at both ends of the bridge unit are respectively lapped on the two adjacent second touch units. The other bridge unit only includes one metal bridge, and two ends of the metal bridge of the other bridge unit are respectively lapped on the two adjacent second touch units.

### CROSS-REFERENCE TO RELATED APPLICATIONS

This application is a continuation of International Patent Application No. PCT/CN2018/089972, filed on Jun. 5, 2018, which claims priority to Chinese Patent Application No. 201721642835.2, filed on Nov. 30, 2017, with a title “TOUCH PANELS AND TOUCH DISPLAY DEVICES”, the entire contents of which are hereby incorporated by reference.

### FIELD

The application relates to a touch technical field.

### BACKGROUND

A touch panel, as an input device is generally applied for an electronic terminal such as a mobile phone, a tablet computer, or a touch panel, and is used for receiving from a user a touch operation command such as clicking, sliding, and the like on the touch panel.

An touch panel generally has a first directional electrode 11 and a second directional electrode 12 located on the same conductive film layer. As shown in FIG. 1a, the first direction and the second direction are perpendicular to each other. An enlarged view of a specific structure is shown in FIG. 1b. The first directional electrode and the second directional electrode are generally block electrodes, and the block electrodes 111 in the first directional electrode are connected to each other, and the block electrodes 121 in the second directional electrode are spaced apart. A bridge unit 13 is generally provided between the adjacent block electrodes 121 of the second directional electrode, and the bridge unit 13 enables the first directional electrode 11 and the second directional electrode 12 insulated from each other and each conductive.

### SUMMARY

Exemplary embodiments of the present application provide touch panels and touch display devices for improving a touch failure problem of the bridge unit of the touch panel after being damaged by static electricity.

The following technical solutions are adopted by the exemplary embodiments of the application.

A touch panel including:

a plurality of first touch electrode patterns arranged in a first direction, the first touch electrode patterns including a plurality of first touch units, and a connection unit connecting two adjacent first touch units;
a plurality of second touch electrode patterns arranged along a second direction and intersectedly insulated from the first touch electrode patterns, wherein the second touch electrode patterns includes a plurality of independent second touch units, and at least one bridge structure connecting two adjacent second touch units; wherein the bridge structure is provided with two bridge units, one bridge unit includes at least two metal bridges and a connecting portion connecting the at least two metal bridges, wherein the metal bridges at two ends of the one bridge unit are respectively lapped on the two adjacent second touch units; the other bridge unit only includes one metal bridge, and two ends of the metal bridge are respectively lapped on the two adjacent second touch units.

Preferably, the connecting portion insulatively overlaps with the first touch electrode patterns.

Preferably, the connecting portion and the first touch electrode patterns have an insulating layer provided therebetween.

Preferably, the first touch electrode patterns are provided with a hollow region, and the connecting portion is insulatively embedded in the hollow region.

Preferably, in the bridge structure, at least one of the metal bridges has a hollow pattern.

Preferably, the hollow pattern of the metal bridges of the two bridge units is rectangular or circular.

Preferably, the hollow pattern of the at least one metal bridge extends along the second direction.

Preferably, there are a plurality of the hollow patterns arranged along an arranging direction perpendicular to the second direction.

Preferably, the hollow pattern comprises two rectangular patterns.

Preferably, the metal bridges of the two bridge units are grid-shaped metal bridges.

Preferably, at least one of the bridge units is arranged along a preset direction, and an angle between the preset direction and the second direction is greater than 0° and less than 90°.

Preferably, the bridge units further include: a contact portion at both ends of the metal bridge for contacting and connecting to the second touch unit or the connecting portion; a width of the contact portion in a direction perpendicular to an extension direction of the bridge unit is larger than a width of the metal bridge.

Preferably, two bridge structures are arranged between the two adjacent second touch units, and the two bridge structures are symmetrically with respect to a center.

Preferably, two adjacent second touch units corresponding to any of the metal bridges respectively have a concave-convex structure at a spaced channel of the two adjacent second touch units; the metal bridge connects the two second touch units with a shortest distance.

Preferably, the concave-convex structure is triangular or rectangular or trapezoidal or semi-circular.

Preferably, the connecting unit for the first touch electrode patterns has a concave-convex structure matched with the concave-convex structure for the second touch electrode patterns.

A touch display device, including the touch panel according to any one of the above touch panels.

The following beneficial effects can be achieved by at least one of the above technical solutions adopted by the exemplary embodiments of the application:

In the technical solutions provided in the present application, at least one bridge structure is arranged between two adjacent second touch units, and two bridge units are arranged in the bridge structure; when one of the bridge units is subjected to electrostatic damages, the touch signals can still be transmitted by another bridge unit. In addition, even if the bridge structure is subjected to multiple electrostatic damages, and the bridge unit in the bridge structure is broken at multiple locations, which causes the touch signal cannot be transmitted between the two adjacent second touch units by the bridge structure, however, other bridge structures between the two second touch units can still ensure the transmission of the touch signals. Moreover, in the present solution, a bridge unit only includes a metal bridge which can effectively reduce the resistance between the two adjacent second touch units. Therefore, the present solutions alleviate the case of touch failure after the bridge unit of the touch panel is damaged by the static electricity. In the case of being subjected to multiple electrostatic damages, the solution can ensure as much as possible that an overall touch performance of the touch panel is not affected, thereby improving an antistatic capability of the touch panel and improving a durability of the touch panel. Meanwhile, the overall resistance of the second touch electrode patterns is reduced as much as possible, thereby improving a touch sensitivity.

### BRIEF DESCRIPTION OF THE DRAWINGS

In the drawings:

FIG. 1a is a schematic structural view of a touch panel;

FIG. 1b is an enlarged structural view of a touch panel;

FIG. 2 is a schematic structural view of a touch panel provided by the present application;

FIG. 3a is a partial enlarged view of the connecting portion and a first touch pattern which are spaced apart in the present application;

FIG. 3b is a partial enlarged view of the connecting portion and a first touch pattern which are overlapped in the present application;

FIG. 3c is a cross-sectional structural view of the connecting portion in the present application;

FIG. 4 is a second schematic structural view of a touch panel provided by the present application;

FIG. 5a is a metal bridge in which a hollow pattern is arranged along a second direction according to the present application;

FIG. 5b is a metal bridge in which a hollow pattern is arranged perpendicular to the second direction according to the present application;

FIG. 5c is a metal bridge having a mesh hollow pattern according to the present application;

FIG. 6a is a third schematic structural view of a touch panel provided by the present application;

FIG. 6b is a schematic view of a metal bridge of a touch panel;

FIG. 6c is a schematic view of a metal bridge of a touch panel in the present application;

FIG. 7 is a fourth schematic structural view of a touch panel provided by the present application;

FIG. 8 is a fifth schematic structural view of a touch panel provided by the present application;

FIG. 9a is a sixth schematic structural view of a touch panel provided by the present application;

FIG. 9b is a seventh schematic structural view of a touch panel provided by the present application.

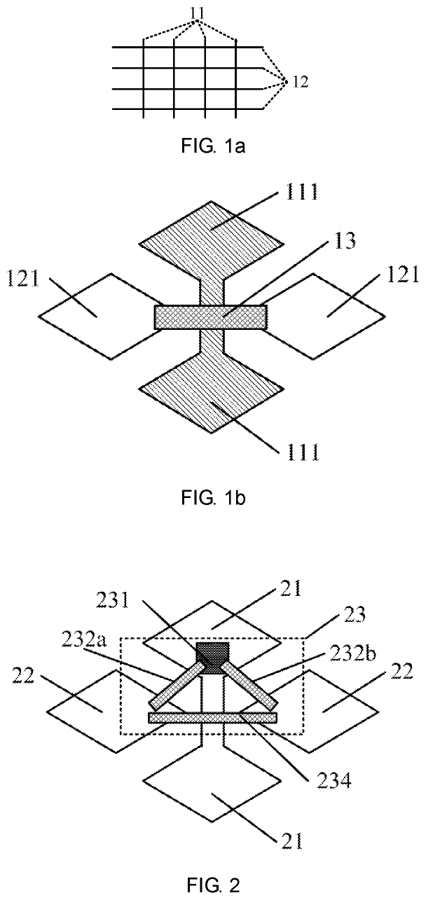

### DETAILED DESCRIPTION

The technical solutions of the present application will be clearly and completely described in the following with reference to the specific exemplary embodiments and the corresponding drawings of the present application.

### Exemplary Embodiment 1

An exemplary embodiment provides a touch panel intended for reducing a touch failure problem of a bridge unit of a touch panel after being damaged by static electricity. FIG. 2 is a schematic structural view of the touch panel, the touch panel includes:

a plurality of first touch electrode patterns arranged in a first direction, the first touch electrode patterns including a plurality of first touch units 21, and a connection unit connecting two adjacent first touch units 21;
a plurality of second touch electrode patterns arranged along a second direction and intersectedly insulated from the first touch electrode patterns, wherein the second touch electrode patterns include a plurality of independent second touch units 22, and at least one bridge structure 23 connecting two adjacent second touch units;
wherein the bridge structure 23 is provided with two bridge units. One bridge unit includes at least two metal bridges 232a, 232b, and a connecting portion 231 connecting the at least two metal bridges; wherein the metal bridges 232a, 232b at two ends of the bridge unit are respectively lapped on the two adjacent second touch units 22. The other bridge unit only includes one metal bridge 234. Two ends of the metal bridge 234 are respectively lapped on the two adjacent second touch units 22.

In this exemplary embodiment, one bridge structure 23 between two adjacent second touch units is taken as an example, but a plurality of bridge structures 23 may be arranged between the two touch units. The specific quantity and size of the bridge structure 23 are not limited here and can be adjusted according to production requirements. In the touch panel structure provided by the exemplary embodiment, since two bridge units are arranged in the bridge structure, the metal bridges 232a and 232b may be broken when receiving a static current with a large current. According to the structure of FIG. 2, when the metal bridge 232a is broken by an electrostatic shock, and signals can not be transmitted, the metal bridge 234 can still ensure the normal transmission of touch signal between the two adjacent second touch units 22. Similarly, if the metal wire 234 is broken due to the electrostatic damage, the two metal bridges 232a, 232b and the connecting portion 231 can still ensure the normal transmission of the touch signal between the two adjacent second touch units. Moreover, in the present solution, one bridge unit only includes a metal bridge 234, which can effectively reduce the resistance between the two adjacent second touch units 22, thereby improving the overall touch sensitivity of the touch panel.

Therefore, the touch panel structure provided by the solution can improve the antistatic electricity capability of the touch panel. The touch signal can still be transmitted between the two second touch units when the touch panel is subjected to an electrostatic damage, thereby reducing the influence of electrostatic damage on the touch performance, and improving the durability of the touch panel. Meanwhile, the overall resistance of the second touch electrode patterns can be reduced as much as possible to improve the touch sensitivity.

### Exemplary Embodiment 2

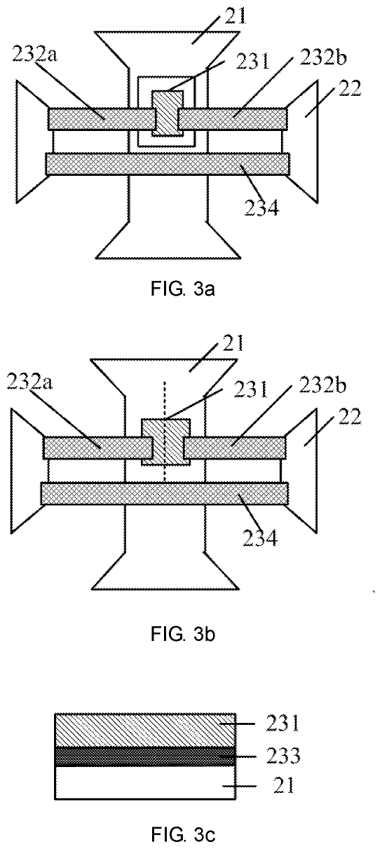

Based on the above exemplary embodiment, the exemplary embodiment provides a touch panel, and the connecting portion is insulatively embedded in a hollow region of the first touch electrode pattern. For details, referring to FIG. 3a. FIG. 3a is a partial enlarged view of the bridge structure 23 between two adjacent second touch units. In FIG. 3a, a bridge unit includes a connecting portion 231 and two metal bridges 232a and 232b. The connecting portion 231 is located in a hollow region of the first touch electrode pattern, and insulatively spaced apart from the first touch electrode pattern. The two metal bridges 232a and 232b are lapped between the second touch unit 22 and the connecting portion 231 to make the two adjacent second touch units 22 conductive. The other bridge unit includes a metal bridge 234 that is lapped between two adjacent second touch units 22. In this configuration, when the touch panel is damaged by static electricity, the touch signals can still be transmitted between the two second touch units 22, thereby reducing the influence of electrostatic damage on the touch performance and improving the antistatic capability of the touch panel, thereby improving durability.

In addition, the above structure can shorten a length of the metal bridges 232a and 232b between the two adjacent second touch units 22 under the premise of ensuring a normal communication of the touch signals, and alleviate the reflection caused by an excessive length of the metal bridge between the two adjacent second touch units 22 to some extent.

In addition, an exemplary embodiment of the present solution further provides another touch panel, and the connecting portion insulatively overlaps with the first touch electrode pattern. A partial enlarged view of the connecting portion is shown in FIG. 3b. In FIG. 3b, a bridge unit includes a connecting portion 231 and two metal bridges 232a, 232b. Wherein the connecting portion 231 overlaps with the first touch electrode pattern, insulated from each other. And the two metal bridges 232a, 232b lap between the second touch unit 22 and the connecting portion 231, so that the two adjacent second touch units 22 can be connected to each other. The other bridge unit includes a metal bridge 234 lapped between two adjacent second touch units. Preferably, the cross-sectional view taken along the dashed line in FIG. 3b is shown in FIG. 3c. In FIG. 3c, an insulating layer 233 is interposed between the connecting portion 231 and the first touch electrode pattern, and the insulating layer 233 can ensure that the first touch electrode pattern and the second touch electrode pattern are insulated from each other to avoid short circuit or signal crosstalk. Moreover, when the touch panel is damaged by static electricity, the touch signals can still be transmitted between the two second touch units 22, thereby reducing the influence of the electrostatic damage on the touch performance and improving the antistatic capability of the touch panel, and thus improving durability. In addition, the structure can shorten the length of the metal bridges between the two adjacent second touch units, and avoid the reflection caused by the excessive length of the metal bridge between the two adjacent second touch units to some extent.

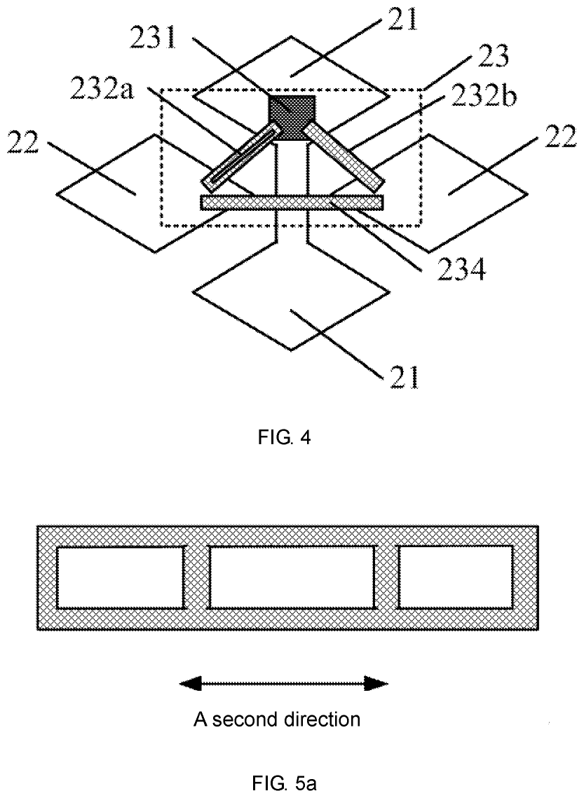

Based on the above structure, in order to further improve the antistatic capability of the touch panel, at least one metal bridge of the bridge structure has a hollow pattern. The specific structure is as shown in FIG. 4. In FIG. 4, a bridge structure 23 is arranged between two adjacent second touch units 22. In the bridge structure 23, one bridge unit includes two metal bridges 232a and 232b connected to the two adjacent second touch units 22 by the connecting portion 231. And the other bridge unit includes a metal bridge 234 that is lapped between the two adjacent second touch units 22. In FIG. 4, taking one metal bridge has a hollow pattern as an example. Specifically, in the three metal bridges of the drawing, a left metal bridge 232a has a rectangular hollow pattern which forms two channels for transmitting touch signals on a metal bridge 232a for transmitting touch signals. When electrostatic damage occurs, one of the two channels transmitting the touch signal may be broken by electrostatic damage. At this time, signal transmission can be continuously conducted by another channel for transmitting the touch signals. Similarly, the metal bridge 232b at the right side and the metal bridge 234 at the lower side in FIG. 4 may be provided with the above structure.

For a bridge unit, the structure provided by the present solution can ensure that signal can still be transmitted between two adjacent second touch units 22 in the event of a breakage of a bridge unit by electrostatic shock, and can further reduce the influence of electrostatic damage on touch performance and improve the antistatic capability of the touch panel, thereby improving durability.

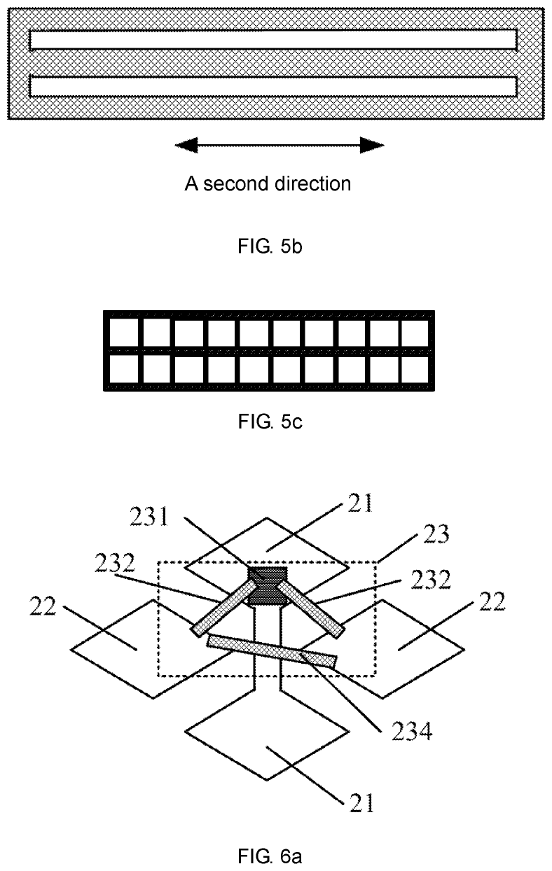

In the above structure, an extension direction of the hollow pattern of the at least one metal bridge is arranged along a second direction. Taking a metal bridge as an example, the metal bridge can be the metal bridge 234 in FIG. 4, and FIG. 5a shows a schematic structural view of the metal bridge with a hollow pattern. The specific hollow pattern can be a rectangle, a circle or other graphics, and the quantity of the hollow pattern specifically depends on the actual production requirements. FIG. 5a shows a hollow pattern arranged along the second direction. In FIG. 5a, taking three rectangular patterns are as an example. In this structure, the touch signal can be transmitted along multiple routes. When any position in the metal bridge is subjected to electrostatic shock, the metal bridge can still ensure the normal signal transmission between the two adjacent second touch electrodes. It can be seen that in the metal bridge structure shown in FIG. 5a, the problem of the touch failure of the touch panel after being damaged by static electricity can be improved.

In addition, the plurality of hollow patterns may also be arranged perpendicular to the second direction. The specific structure is as shown in FIG. 5b, and the hollow patterns may specifically be two rectangular patterns. The two rectangular patterns on the metal bridge perpendicular to the second direction divide the metal bridge into upper, middle and lower channels for transmitting touch signals. When the user releases static electricity to the touch panel during the touch operation, the transmission channel may be broken due to the damage of the metal bridge caused by static electricity. If the first transmission channel located above is damaged by static electricity, the electrical signals can still be transmitted in the two transmission channels located in the middle and below between the two adjacent second touch electrodes. Therefore, the metal bridge provided by the solution can still ensure the transmission of the touch signal on the touch panel after being damaged by the static electricity to some extent, thereby improving the antistatic capability of the touch panel and alleviating the touch fails of the touch panel after electrostatic damage.

For the touch pattern, preferably, as shown in FIG. 5c, when the touch signal is transmitted through the metal bridge with a grid shape, there are a plurality of transmission paths for the touch signal, and the touch signal can be transmitted along any one of the transmission paths. When the grid-shaped metal bridge is damaged by static electricity, a fracture is formed at the damaged part, but signals can still be transmitted by the grids that are not fractured by the damage. Therefore, the structure provided by the present application can improve the antistatic capability of the touch panel and improve the problem of the touch failure of the touch panel after electrostatic damage.

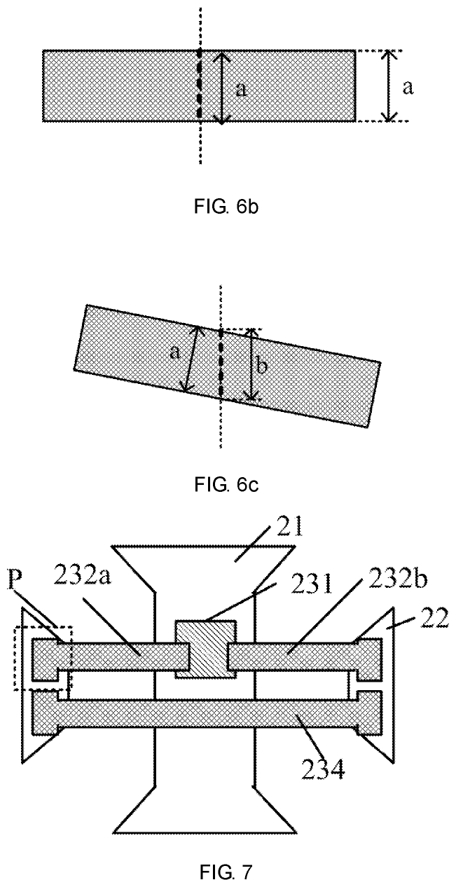

Based on the above exemplary embodiments, an exemplary embodiment of the present solution further provides a touch panel, wherein the at least one bridge unit is arranged along a preset direction, wherein an angle between the preset direction and the second direction is greater than 0° and less than 90°. The specific structure is shown in FIG. 6a. In FIG. 6a, taking one bridge structure as an example. In the bridge structure, one bridge unit includes only one metal bridge 234, and an angle between the arrangement direction of the metal bridge 234 and the second direction is greater than 0° and less than 90°. For the touch panel, bending deformation occurs correspondingly when subjected to an external force. For the existing touch panel structure, a partial enlarged view of the metal bridge is shown in FIG. 6b. If the touch panel is subjected to an external force, it is bent along the broken line, and the bending line of the metal bridge is shown by a thick line in the drawing. Moreover, a width of the metal bridge is a. For the existing structure, the length of the bending line for dispersing stress on the bridge unit during bending is the same as the width of the metal bridge, that is, the bending stress can be dispersed on the bending line.

For the touch panel structure provided by the present solution, if the metal bridge is bent along the broken line, the bending line of the metal bridge is shown by a broken line in the drawing. Moreover, the width of the metal bridge is a, and the length of the bending line for dispersing stress on the bridge unit during bending is b, as can be seen from the drawing, b is larger than a, that is, the stress in the structure of the present solution is more dispersed than that in the prior art. For the same metal bridge bent at the same position, compared with the prior art, the present scheme has a longer bending line, that is, the stress can be more uniformly dispersed. For the same bending force, in the structure of the solution, the stress can be more uniformly dispersed. The bending stress is dispersed at various positions of the metal bridge, so that any position of the metal bridge located on the bending line is subjected to less stress, thereby reducing the breakage of the metal bridge when subjected to bending stress, and ensuring that the touch signal can be normally transmitted by the touch panel, thereby improving durability of the touch panel.

In addition, the present exemplary embodiment further provides another touch panel structure. As shown in FIG. 7, the bridge unit further includes: a contact portion P at both ends of the metal bridge for contacting and connecting to the second touch unit 22 or the connecting portion 231. A width of the contact portion P in a direction perpendicular to an extension direction of the bridge unit is larger than a width of the metal bridge.

The specific structure is as shown in FIG. 7. In this structure, the contact surface of the metal bridge and the second touch unit 22 is large. Since a contact resistance is inversely proportional to a contact area, thus a large contact area can effectively reduce the contact resistance between the metal bridge and the second touch unit 22. In the second touch electrode pattern of the touch panel, if the contact surface of each of the metal bridges and the second touch unit 22 has the structure of the exemplary embodiment, the overall resistance of the display panel can be effectively reduced, and the overall sensitivity of the touch panel can be improved.

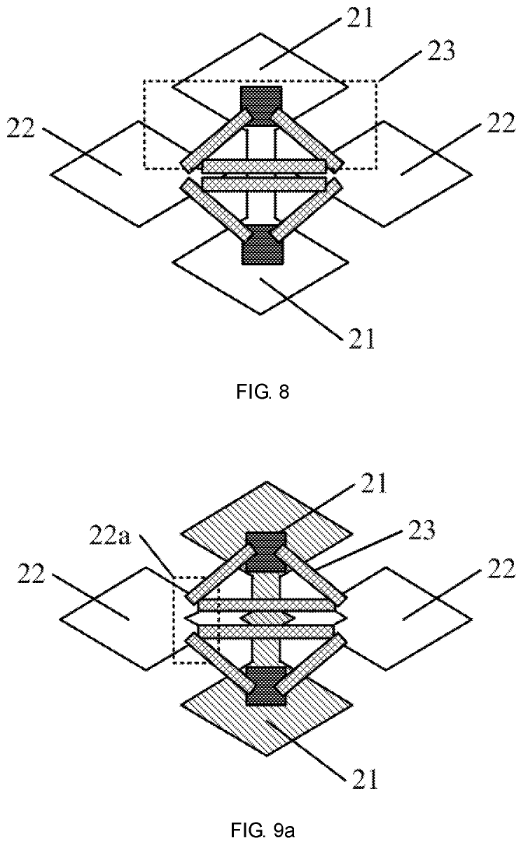

In addition, in an exemplary embodiment, a plurality of bridge structures may be arranged between two adjacent second touch units 22, and preferably, two bridge structures may be arranged, as shown in FIG. 8. In FIG. 8, two bridge structures 23 are arranged between the adjacent second touch units 22, and the two bridge structures are symmetrically arranged along the center, and are also symmetrically arranged along the second direction. In this configuration, there are four bridge units between the two second touch units 22 for transmitting signals. When one of the metal bridges is damaged by static electricity, the other bridge units can still ensure the signal transmission between the two second touch units 22. It can be seen that the structure can further improve the capability of anti-static electricity damage of the touch panel, relieve the problem of the touch panel failure after the electrostatic damage, and further prolong the service life of the touch panel.

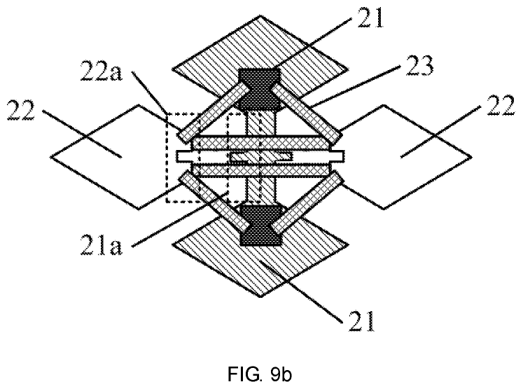

Based on the structure provided by the foregoing exemplary embodiment, the present solution further provides a touch panel. Referring to FIG. 9a, the two adjacent second touch units 22 corresponding to any of the bridge structures 23 respectively have a concave-convex structure 22a at the spaced channel. The bridge unit connects the two second touch units 22 with the shortest distance.

In FIG. 9a, the second touch unit 22 has a concave-convex structure which is triangular, as shown in the curved box indicated by 22a in FIG. 9a. Similarly, the concave-convex structure can also be rectangular, as shown by the dashed box indicated by 22a in FIG. 9b. In addition, the concave-convex structure may be other patterns such as a trapezoid, a semicircle, or the like. In the above structure, since the second touch unit 22 has a concave-convex structure, and the bridge unit is connected within the two adjacent second touch units 22 with the shortest distance, thus the length of the bridge unit is short. Since the metal bridge in the bridge unit is usually made of a metal material, the touch panel is generally laminated with the display panel in the electronic device, in the present schemes, the occurrence of metal reflection on the touch panel can be avoided as much as possible by shortening of the length of the metal bridge unit 23, thereby avoiding the influence on the display performance. In addition, shorter metal bridges are less prone to breakage than longer metal bridges. Therefore, shortening the length of the metal bridge can further improve the overall durability of the touch panel, especially for the flexible touch panel, the shorter metal bridge can further improve the resistance to bend of the touch panel.

Based on the structure provided by the foregoing exemplary embodiment, an exemplary embodiment of the present solution further provides a touch panel, referring to FIG. 9a, the connecting unit of the first touch electrode pattern has a concave-convex structure 21a matched with the concave-convex structure 22a of the second touch electrode pattern.

The connecting unit in the first touch electrode pattern in FIG. 9a and FIG. 9b is used to communicate the touch signals between the two adjacent touch units 22. When the second touch electrode pattern has the concave-convex structure 22a, to ensure the transmission of the touch signals between the two adjacent second touch units 22, and prevent the width of the transmission touch signal from being too narrow, the connecting unit of the first touch electrode pattern in the exemplary embodiment, has a shape adapted to the concave-convex structure 22a of the second touch unit, thereby effectively preventing the channel for transmitting the touch signals from being too narrow, reducing the overall resistance of the touch panel, and improving the touch sensitivity of the overall touch panel.

### Exemplary Embodiment 3

A touch display device includes any one of the touch panels involved in the above exemplary embodiments. The touch display device can be applied to an electronic device with a touch display function. The touch display device provided in the exemplary embodiments can reduce the problem of touch failure after the touch panel bridge unit is damaged by static electricity, thereby improving the overall anti-static capability of the touch display device, and extending the service life of the device.

In addition, the display device can be any product or component with a display function such as a mobile phone, a tablet computer, a television, a display, a notebook computer, a digital photo frame, a navigator, a smart wearable device or the like. Other indispensable components of the display device are understood by a person skilled in the art, and are not described herein, nor should they be construed as an limitation to the application.

The above description is only the exemplary embodiments of the application, and is not intended to limit the application. For a person skilled in the art, there can be various changes and modifications to the application. Any modification, equivalent replacement or improvement made within the spirit and principle of the application, should be included in the protection scope of the claims of the application.

What is claimed is:

1. A touch panel comprising:
a plurality of first touch electrode patterns arranged in a first direction, the first touch electrode patterns comprising a plurality of first touch units, and a connection unit connecting two adjacent first touch units;
a plurality of second touch electrode patterns arranged along a second direction and intersectedly insulated from the first touch electrode patterns, the second touch electrode patterns comprising a plurality of independent second touch units, and at least one bridge structure connecting two adjacent second touch units; wherein:
the bridge structure is provided with two bridge units, one bridge unit of the two bridge units comprises at least two metal bridges and a connecting portion connecting the at least two metal bridges; wherein the metal bridges of the one bridge unit are respectively lapped on the two adjacent second touch units;
the other bridge unit only comprises one metal bridge, and two ends of the metal bridge of the other bridge unit are respectively lapped on the two adjacent second touch units.

2. The touch panel according to claim 1, wherein the connecting portion insulatively overlaps with the first touch electrode patterns.

3. The touch panel according to claim 1, wherein the connecting portion and the first touch electrode patterns have an insulating layer provided therebetween.

4. The touch panel according to claim 1, wherein
the first touch electrode patterns are provided with a hollow region, and the connecting portion is insulatively embedded in the hollow region.

5. The touch panel according to claim 1, wherein in the bridge structure, at least one of the metal bridges has a hollow pattern.

6. The touch panel according to claim 5, wherein the hollow pattern of the metal bridges of the two bridge units is rectangular or circular.

7. The touch panel according to claim 5, wherein the hollow pattern of the at least one metal bridge extends along the second direction.

8. The touch panel according to claim 5, wherein there are a plurality of the hollow patterns arranged along an arranging direction perpendicular to the second direction.

9. The touch panel according to claim 8, wherein the hollow pattern comprises two rectangular patterns.

10. The touch panel according to claim 1, wherein the metal bridges of the two bridge units are grid-shaped metal bridges.

11. The touch panel according to claim 1, wherein at least one of the bridge units is arranged along a preset direction, and an angle between the preset direction and the second direction is greater than 0° and less than 90°.

12. The touch panel according to claim 1, wherein the two bridge units further comprise a contact portion formed at two ends of the metal bridge for contacting and connecting to the second touch unit or the connecting portion, a width of the contact portion in a direction perpendicular to an extension direction of the bridge unit is larger than a width of the metal bridge.

13. The touch panel according to claim 1, wherein a plurality of the bridge structures are arranged between the two adjacent second touch units.

14. The touch panel according to claim 13, wherein two bridge structures are arranged between the two adjacent second touch units, and the two bridge structures are symmetrically with respect to a center.

15. The touch panel according to claim 1, wherein two adjacent second touch units corresponding to any of the metal bridges respectively have a concave-convex structure at a spaced channel of the two adjacent second touch units; the metal bridge connects the two adjacent second touch units with a shortest distance.

16. The touch panel according to claim 15, wherein the concave-convex structure is triangular or rectangular or trapezoidal or semi-circular.

17. The touch panel according to claim 15, wherein the connecting unit for the first touch electrode patterns has a concave-convex structure matched with the concave-convex structure for the second touch electrode patterns.

18. A touch display device, comprising the touch panel according to claim 1.
